(19) United States
(12) Patent Application Publication
(10) Pub. No.: US 2006/0095660 A1
(43) Pub. Date: May 4, 2006

(54) Media storage apparatus, cache segment switching method of media storage apparatus, and media storage system

(75) Inventors: Masahiro Ito, Higashine (JP); Kenichi Sutou, Higashine (JP); Kenji Yoneki, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/082,455

(22) Filed: Mar. 17, 2005

(30) Foreign Application Priority Data
Nov. 1, 2004 (JP) 2004-318166

(51) Int. Cl. G06F 12/00

(52) U.S. Cl. 711/113

(57) ABSTRACT

A media storage apparatus switches the number of segments of a cache memory according to a data transfer amount from an external device at high speed according to a successive data transfer amount from the external device. A media storage apparatus receives both succession information of write data, and a data transfer amount per command, from an external device. On recognizing that the write data are successive, the media storage apparatus modifies the number of segments of a cache memory according to the data transfer amount. With this, the number of segments can be modified immediately to the number suitable for write processing of the write data of the transfer amount, and high-speed write processing can be achieved.

### CROSS-REFERENCE TO RELATED APPLICATIONS

This application is based upon and claims the benefit of priority from the prior Japanese Patent Application No. 2004-318166, filed on Nov. 1, 2004, the entire contents of which are incorporated herein by reference.

### BACKGROUND OF THE INVENTION

1. Field of the Invention

The present invention relates to a media storage apparatus having a cache memory, a cache segment switching method of the media storage apparatus, and a media storage system, and more particularly a media storage apparatus in which the number of divided segments in the cache memory is dynamically modified, a cache segment switching method of the media storage apparatus, and a media storage system.

2. Description of the Related Art

With an improved access speed in recent years, a media storage apparatus such as magnetic disk unit, optical disk unit, magneto-optical disk unit is provided with a cache memory, for temporarily storing write data transferred from an upper-level device or read data transferred from a medium. By use of the cache memory, when writing data, the write data transferred from the upper-level device can be stored in the cache memory. Then, the data are written onto the medium (which is termed ‘write back’). Thus, it becomes possible to absorb a relatively low writing speed of the medium.

Also, when reading a medium, not only the read data to be accessed, but also the data stored in the vicinity of the data to be accessed are stored into the cache memory, so it becomes possible to improve a response speed by transferring data in the cache memory to an upper-level device, when the data to be read in by a subsequent read/write access is existent in the cache memory, or by updating data in the cache memory.

In general, since a substantially large data can be stored in such a cache memory, it is effective to divide the cache memory area into a plurality of segments in view of searching for an object data. However, if each segment size and the number of divided segments are fixed, it is difficult to obtain an effective use of the cache memory, because each transfer amount requested from a request source device is variable. Also, the number of read/write times is increased in a media storage apparatus performing read/write operation on a segment-by-segment basis, which makes it difficult to obtain sufficient performance.

To cope with the above-mentioned problem, there has been proposed a variety of methods of dynamically modifying the number of segments according to a data transfer amount instructed from an upper-level device. A first conventional method is to provide in a media storage apparatus a function of learning a data transfer amount or read/write access types (single access or sequential access, or the like), and to modify the number of divided segments when the number of the divided segments is not appropriate. Such a method has been disclosed, for example, in the official gazette of the Japanese Unexamined Patent Publication No. Hei-7-319,771.

A second conventional method is to modify the number of divided segments by the logical format types (cluster size, etc.) of the medium, as having been disclosed in the official gazette of the Japanese Unexamined Patent Publication No. 2000-227,865.

Now, in recent years, a system for directly transferring data between devices is becoming in use, by use of an interface such as USB (Universal Serial Bus) interface or an internal bus, without connecting to a host computer. Such a system is exemplified by a data transfer system from a mobile terminal, a digital camera or a memory card, to a large-capacity disk drive unit. In such usage, though accesses occur not so frequently, a large amount of data is often transferred at a time. Therefore, a high-speed process suitable for each use environment is required. In the conventional first method described above, a history of the data transfer amounts and the access types is recorded for a predetermined number of times, and the number of divided segments is modified based on the recorded history. However, according to this conventional method, the number of segments is not modified until the learning is performed. Therefore, it is difficult to set an optimal number of segments at high speed in each environment. Namely, this method has a problem of being unable to exhibit high speed on the media storage apparatus until the learning is performed.

Meanwhile, the aforementioned second conventional method depends on the format of a recording medium only, which makes it difficult to adapt to successive data transfer of a request source device having a variety of capacities, and may be unable to obtain a desired effect which is to be brought about by dividing into segments.

### SUMMARY OF THE INVENTION

Accordingly, it is an object of the present invention to provide a media storage apparatus with improved high-speed processing by use of a cache memory, in which optimal segment division is performed at high speed even when successive data transfer each having a variety of transfer amount is performed, and a cache segment switching method of the media storage apparatus, and a media storage system.

It is another object of the present invention to provide a media storage apparatus with improved high-speed processing by use of a cache memory, in which optimal segment dividing is performed at high speed according to each data copy amount requested from a request source device, and a cache segment switching method of the media storage apparatus, and a media storage system.

It is still another object of the present invention to provide a media storage apparatus with improved high-speed processing by use of a cache memory, in which optimal segment division is obtained at high speed for successive data transfer, without changing the conventional command format, and a cache segment switching method of the media storage apparatus, and a media storage system.

It is still another object of the present invention to provide a media storage apparatus for applying a high-speed and optimal segment dividing function to a USB device capable of connecting to a variety of devices, and a cache segment switching method of the media storage apparatus, and a media storage system.

In order to achieve the aforementioned objects, the present invention provides a media storage apparatus which stores write data transferred from an external device. The media storage apparatus includes: a media drive unit recording data on a medium; a cache memory storing the write data transferred from the external device; and a controller managing the number of segments in the cache memory, and recording the write data stored in the cache memory on the media drive unit. In the media storage apparatus, the controller sets the number of segments of the cache memory according to data succession information and a data transfer amount per command, which are notified from the external device prior to the write data transfer.

According to the present invention, in a cache segment switching method of a media storage apparatus storing write data transferred from an external device, the cache segment switching method includes the steps of: setting the number of segments in a cache memory according to data succession information and a data transfer amount per command, which are notified from the external device prior to the write data transfer; storing the write data transferred from the external device into the cache memory on a basis of each set segment; and recording the write data stored in the cache memory on a media.

According to the present invention, a media storage system includes: an external device issuing a write command and write data; and a media storage apparatus storing the write data transferred from the external device. The media storage apparatus further includes: a media drive unit recording data on a medium; a cache memory storing the write data transferred from the external device; and a controller managing the number of segments in the cache memory, and recording the write data stored in the cache memory on the media drive unit. The external device notifies the media storage apparatus of data succession information of the write data and a data transfer amount per command, prior to the write data transfer, and the controller sets the number of segments of the cache memory according to the data succession information and the data transfer amount per command.

According to the present invention, preferably, the controller sets the number of segments of the cache memory according to the data succession information and the data transfer amount per command, which are notified from the external device using the CDB format, prior to the write data transfer.

According to the present invention, preferably, the controller has a table in which the number of segments of the cache memory depending on the data transfer amount per command received from the external device is stored, and on receipt of the data succession information, the controller sets the number of segments of the cache memory by referring to the table.

According to the present invention, preferably, the controller sets the number of segments of the cache memory according to the data succession information and the data transfer amount per command, which are set in a write command notified from the external device using the CDB format, prior to the write data transfer.

According to the present invention, preferably, the controller sets the number of segments of the cache memory according to the data succession information being set in a vendor command, and the data transfer amount per command being set in a write command, which are notified from the external device using the CDB format, prior to the write data transfer.

According to the present invention, preferably, the controller controls the media drive unit to perform write operation on a basis of each segment of the cache memory.

According to the present invention, preferably, the media drive unit is constituted of a drive mechanism which writes data on the medium with a head.

Further scopes and features of the present invention will become more apparent by the following description of the embodiments with the accompanied drawings.

### BRIEF DESCRIPTION OF THE DRAWINGS

FIG. 1 shows a block diagram of a media storage system according to an embodiment of the present invention.

FIG. 2 shows a block diagram of a portable terminal and a converter shown in FIG. 1.

FIG. 3 shows a block diagram of a media storage system according to another embodiment of the present invention.

FIG. 4 shows a block diagram of a media storage apparatus shown in FIGS. 1 and 3.

FIG. 5 shows a structure diagram of a segment division table shown in FIG. 4.

FIG. 6 shows a structure diagram of a segment management table shown in FIG. 4.

FIG. 7 shows an explanation diagram of CDB (control data block), according to the first embodiment of the present invention.

FIG. 8 shows a sequence diagram of controlling the number of segments, according to the first embodiment of the present invention.

FIG. 9 shows a process flowchart of CDB shown in FIG. 7.

FIG. 10 shows an explanation diagram of the operation shown in FIG. 9.

FIG. 11 shows an explanation diagram of other operation shown in FIG. 9.

FIGS. 12(A) and 12(B) show explanation diagrams of drive operation according to the present invention.

FIG. 13 shows an explanation diagram of CDB (control data block) of a vendor command, according to a second embodiment of the present invention.

FIG. 14 shows an explanation diagram of CDB of a write command, according to the second embodiment of the present invention.

FIG. 15 shows a sequence diagram of controlling the number of segments, according to the second embodiment of the present invention.

FIG. 16 shows a process flowchart of the control shown in FIG. 15.

FIG. 17 shows a block diagram of a composite media storage system, according to a third embodiment of the present invention.

FIG. 18 shows an explanation diagram of the operation shown in FIG. 17.

FIG. 19 shows an upper plan view of the composite media storage system, according to a fourth embodiment of the present invention.

FIG. 20 shows a side plan view of the composite media storage system, according to the fourth embodiment of the present invention.

FIG. 21 shows a block diagram of the composite media storage system, according to the fourth embodiment of the present invention.

### DETAILED DESCRIPTION OF THE INVENTION

The preferred embodiment of the present invention is described hereinafter, in order of media storage system, first embodiment, second embodiment, third embodiment, and other embodiments.

Media Storage System

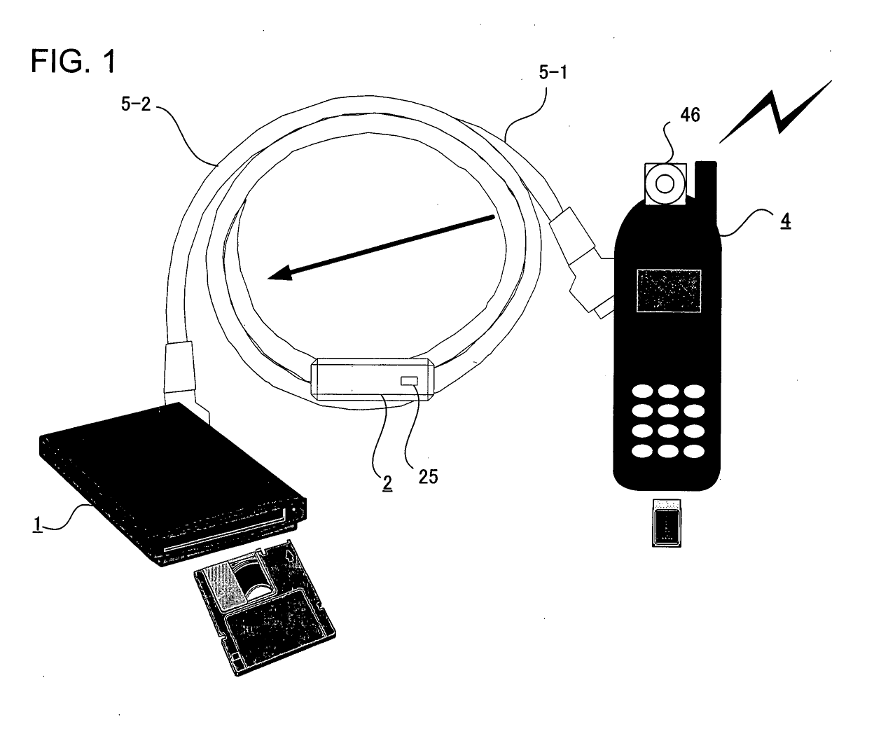

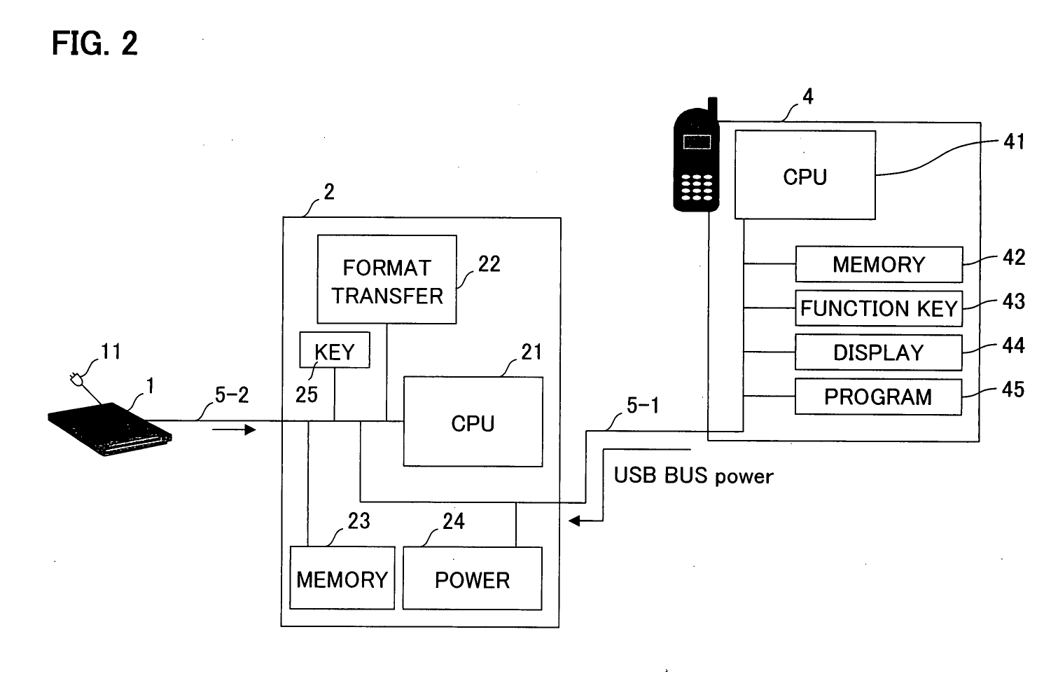

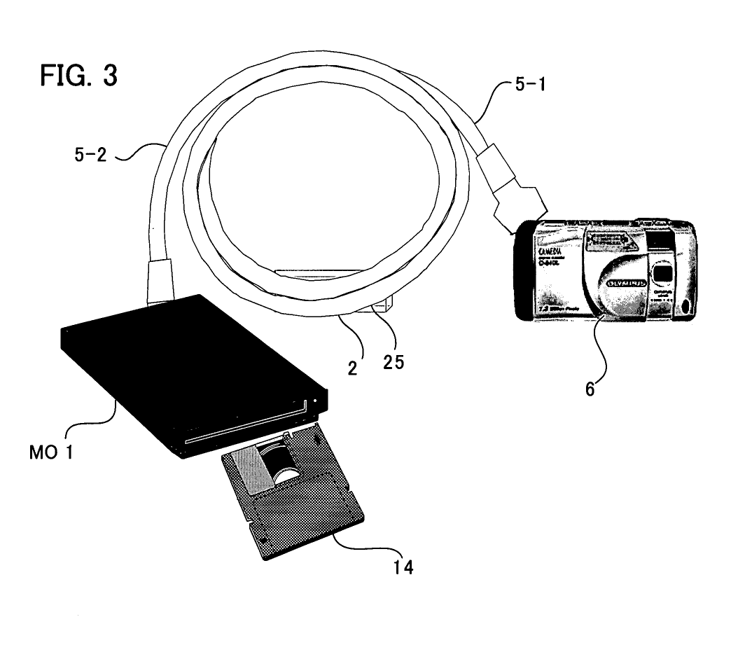

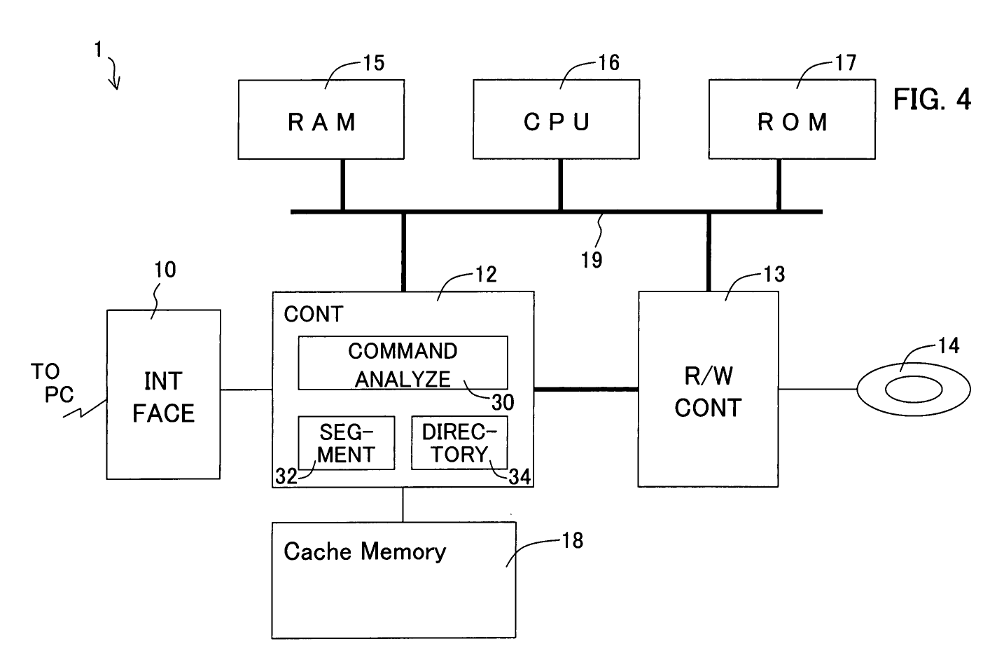

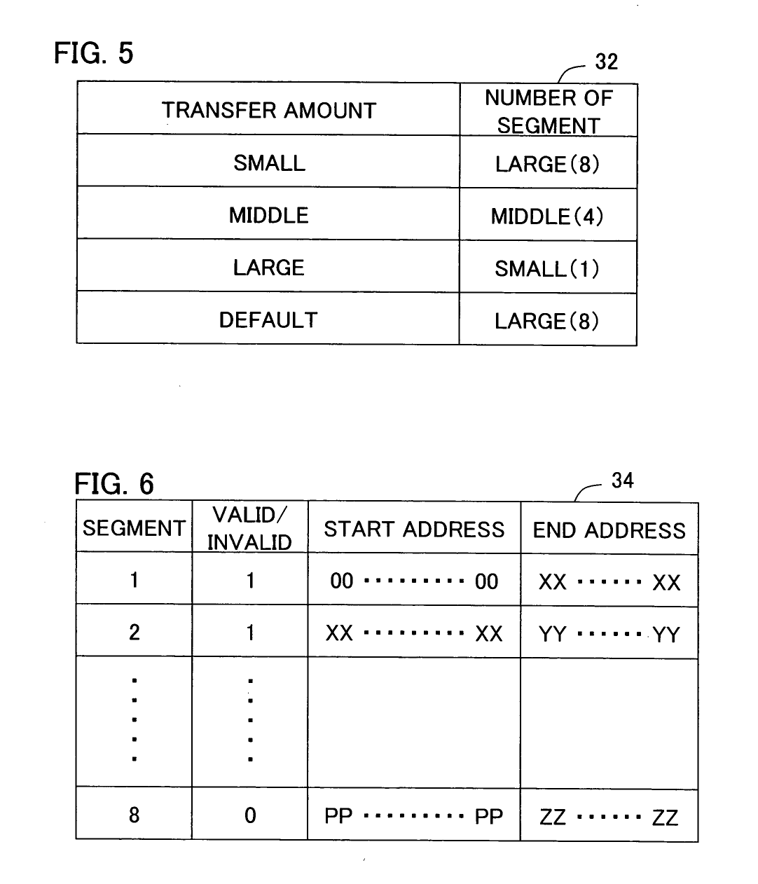

FIG. 1 is a block diagram of a media storage system according to one embodiment of the present invention; FIG. 2 is a block diagram of a mobile device and an interface converter shown in FIG. 1; FIG. 3 is a block diagram of a media storage system according to another embodiment of the present invention; FIG. 4 is a block diagram of a media storage apparatus shown in FIGS. 1 and 3; FIG. 5 is a structure diagram of a segment division table shown in FIG. 4; and FIG. 6 is a structure diagram of a segment management table shown in FIG. 4. In FIGS. 1 through 6, a magneto-optical disk unit is exemplified as media storage apparatus.

As shown in FIG. 1, a portable telephone (telephone with camera) 4 includes a digital camera 46 on the main body thereof. An image photographed with the digital camera 46 is stored in a built-in memory or a detachable memory cartridge 48 as data. To store the image data recorded in the built-in memory or memory cartridge 48 into a large-capacity magneto-optical disk (MO disk) 14 of a media storage apparatus (magneto-optical disk unit, or MO unit) 1, an external device 2 such as a USB data converter is provided between the built-in memory or memory cartridge 48 and MO unit 1. The USB converter 2 has a transfer start key 25. The USB data converter 2 is connected to portable telephone 4 via a first USB cable 5-1, and also connected to the MO unit 1 via a second USB cable 5-2.

As shown in FIG. 2, the portable telephone 4 includes CPU 41, memory 42, function keys 43, display unit 44 and program memory 45. The portable telephone 4 supplies USB bus power via the first USB cable 5-1. Further, USB converter 2 includes CPU 21, format converter 22, memory 23, power supply 24 and transfer key 25.

This format converter 22 converts the image data transferred from the portable telephone 4 into a USB command format, which is described later. Through the second USB cable 5-2, the image data is transferred to the MO unit 1. An AC input plug 11 is provided for the MO unit 1.

FIG. 3 is a configuration diagram of another media storage system using the aforementioned USB converter 2. Through this USB converter 2, the image data recorded in the memory of digital camera 6 is transferred and stored into a large-capacity magneto-optical disk (MO disk) 14 of a media storage apparatus (MO unit) 1. The USB converter 2 has a transfer start key 25. The USB converter 2 is connected to the digital camera 6 via a first USB cable 5-1, and also connected to the MO unit 1 via a second USB cable 5-2.

Meanwhile, as shown in FIG. 4, the MO unit 1 includes an interface circuit 10 for connecting to the external device 2, disk controller 12, read/write controller 13, disk drive (including MO disk) 14, CPU 16 for controlling the operation of the disk drive 14, RAM (random access memory) 15 for the process by CPU 16, ROM (read-only memory) 17 for storing a processing program of CPU 16, cache memory (which is also termed buffer memory) 18, and bus 19 for interconnecting CPU 16, RAM 15, ROM17, disk controller 12 and read/write controller 13.

The disk drive 14 is constituted of a known MO drive. For example, the disk drive 14 includes a spindle motor for rotating an MO disk, an optical head for reading/writing data stored the MO disk, and an actuator for positioning the optical head to a desired track position on the MO disk.

The read/write controller 13 includes data format control circuit, read amplifier, binary coding circuit, write driver, actuator driver, control circuits therefor, focusing/tracking servo control circuit for optical head, etc. The disk controller 12 further includes a command analyzer 30 for analyzing a command from the external device 2 or CPU 16, a segment division table 32 which will be illustrated in FIG. 5, and a segment management (directory) table 34 for managing the segments of the cache memory 18, which will be illustrated later in FIG. 6.

The segments of the cache memory 18 are managed using the segment management table 34. Write data or read data are stored in the cache memory 18 on a segment-by-segment basis. The cache memory 18 is constituted of, for example, a memory having a capacity of 2 Megabyte (MB). When the number of segments is eight (8), the capacity of one segment becomes 250 kilobyte (KB), while when the number of segments is sixteen (16), the capacity of one segment becomes 125 KB.

CPU 16 receives a command having been analyzed in the disk controller 12, and controls the read/write controller 13 according to the command. And CPU 16 controls disk drive 14 so as to read or write data on a track according to the command, and returns a response to the disk controller 12.

When reading, the disk controller 12 refers to the cache memory 18, and if requested data exist, transfers the read data from the cache memory 18 to the external device 2, while if requested data do not exist, receives read data from the read/write controller 13, and stores the read data into the cache memory 18, and then transfers the data to the external device 2. Meanwhile, when writing, the disk controller 12 stores a write data received from the external device 2 into the cache memory 18, and thereafter writes back the data into a disk of the disk drive 14, through the read/write controller 13.

Now, referring to FIG. 5, the segment division table 32 is explained below. As shown in FIG. 5, the number of divided segments according to the maximum data amount per transfer is stored in this segment division table 32. For example, each data transfer amount is classified into three: small, medium, and large. According to each amount, the number of divided segments, classified as large (for example, 8), medium (for example, 4) or small (for example, 1), is stored. Here, as initial value (default value) of the number of segments, the large (for example, 8) is stored.

Namely, in the segment division table 32 shown in FIG. 5, each number of divided segments is stored correspondingly to each data transfer amount, and the number of divided segments, the large, is stored as the initial value (default value). In this example, the numbers of divided segments are shown by 8, 4 and 1. However, it is not necessarily limited to these values.

As shown in FIG. 6, the segment management table 34 stores an indication whether each segment of cache memory 18 is valid or invalid, together with the start and end addresses (links) of each segment when the segment concerned is valid. The disk controller 12 refers to the segment division table 32, and the updates segment management table 34 according to the number of divided segments, which is determined as described in the following.

### First Embodiment

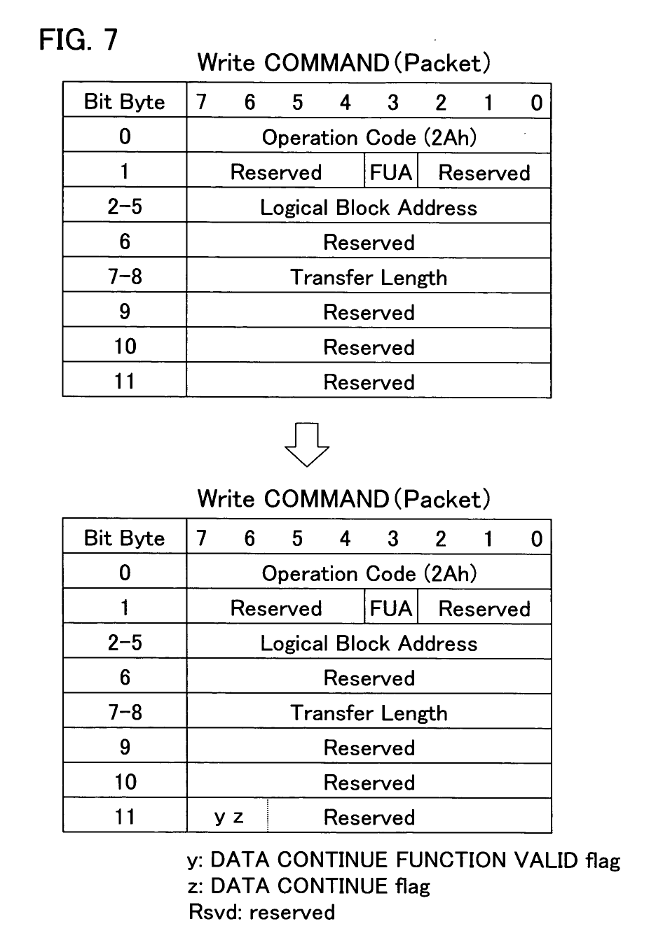

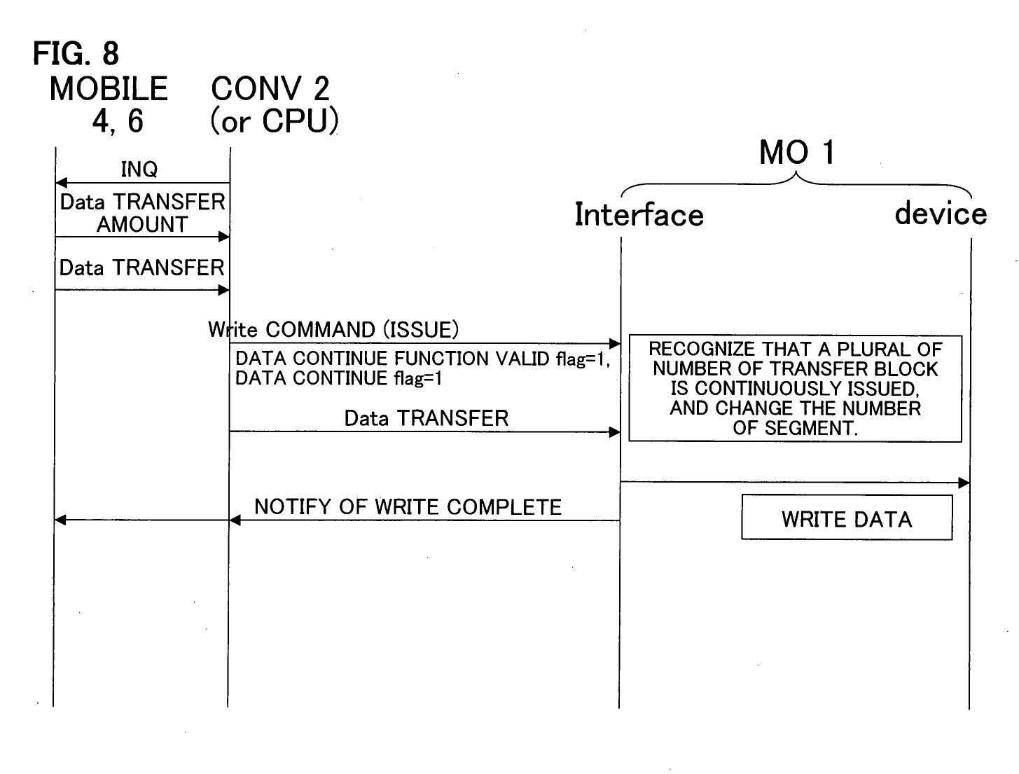

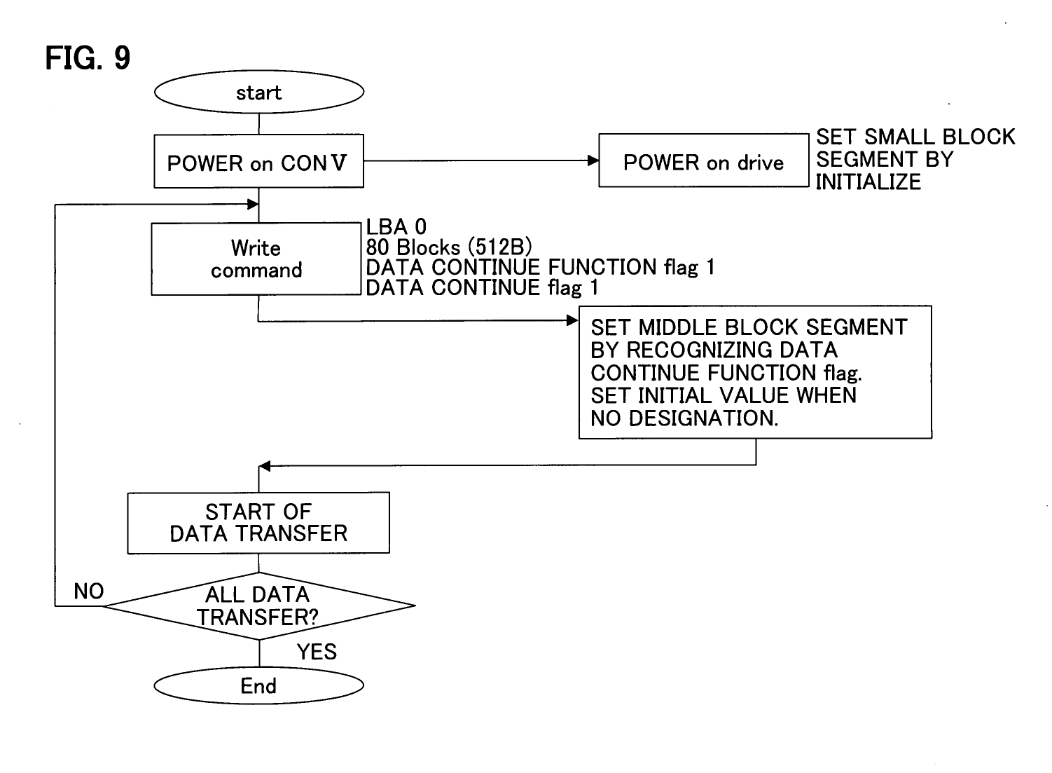

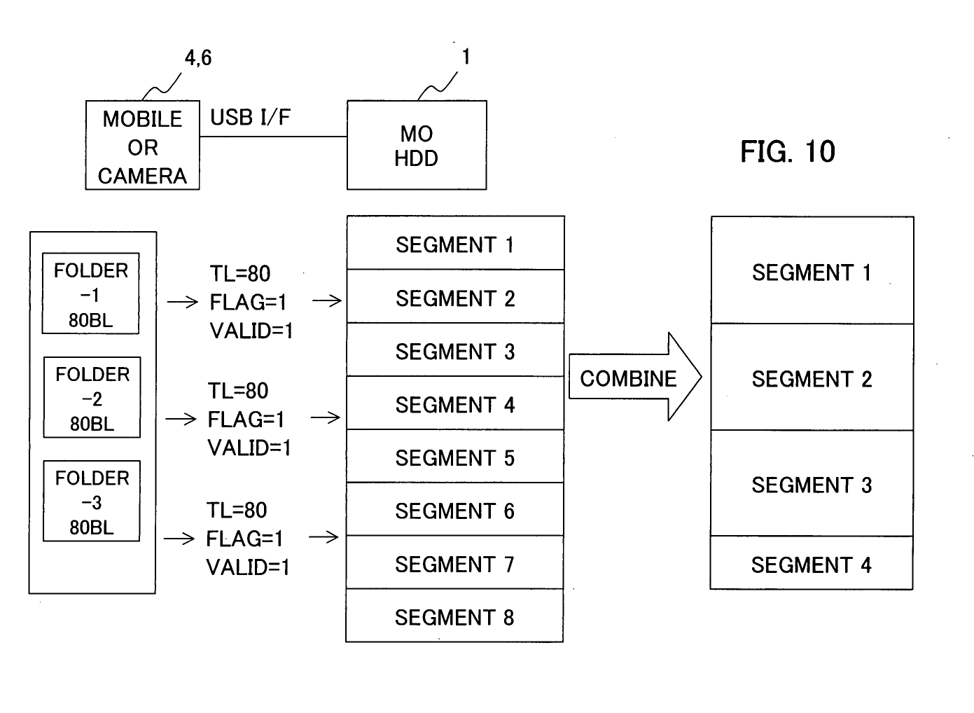

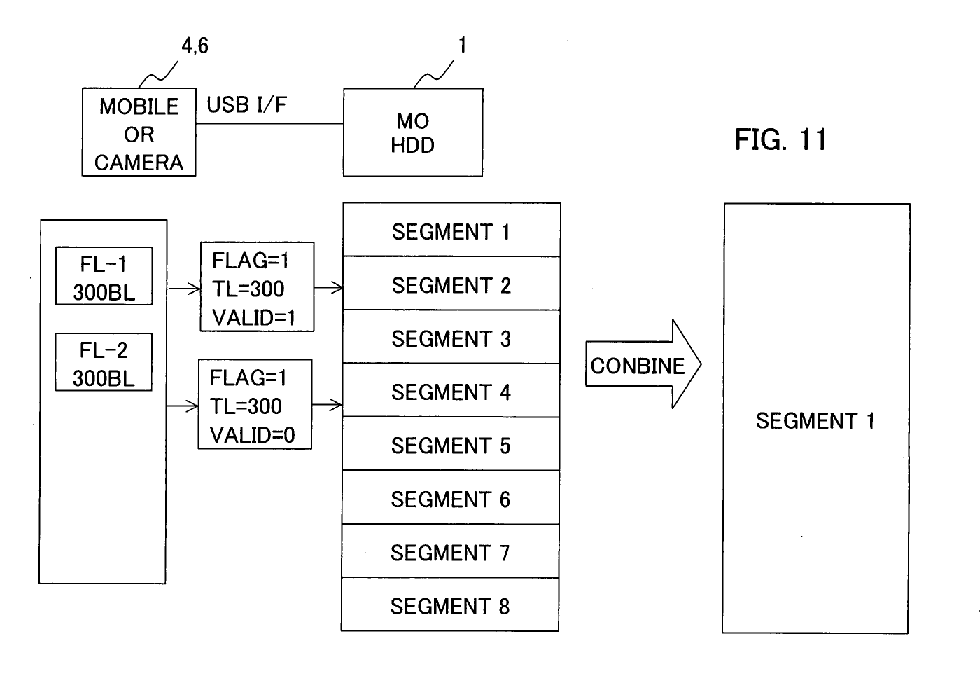

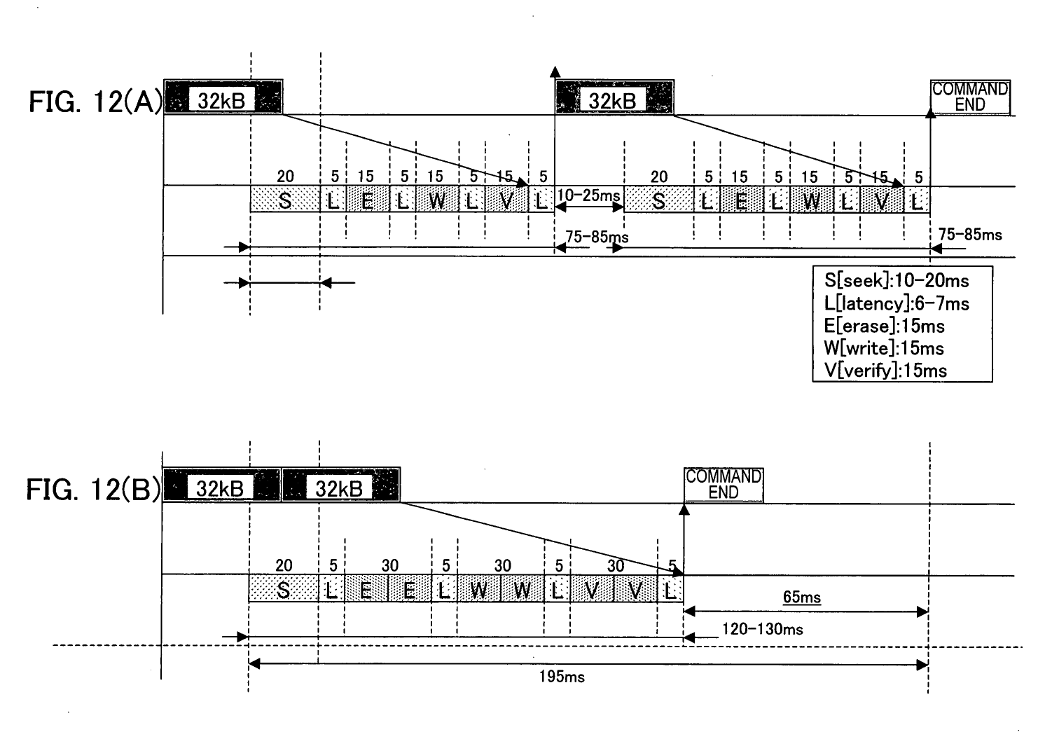

FIG. 7 is an explanation diagram of a CDB (Control Data Block) in the first embodiment of the present invention; FIG. 8 is a sequence diagram for controlling the number of segments in the first embodiment of the present invention; FIG. 9 is a process flowchart of the CDB shown in FIG. 7; FIGS. 10 and 11 are explanation diagrams of the operation shown in FIGS. 7-9; and FIGS. 12(A) and 12(B) are explanation diagrams of drive operation according to the present invention.

As shown in FIG. 7, a write command (control data block, or CDB) issued by the USB format converter 2 is constituted of 12 bytes. The 0-th byte is an operation code (write, read, etc.), the 2nd-5th bytes are a logical block address, and the 7th-8th bytes are a transfer length. The remainder bytes are reserved, which can be used arbitrarily by a vender or a user.

According to the present invention, in the reserved bytes of CDB, a data succession validity flag ‘y’ and a data succession flag ‘z’ are defined. For example, when a write command is issued as CDB format, the data succession validity flag ‘y’ and the data succession flag ‘z’ are described in the 11th byte, as shown in the bottom line of FIG. 7. The data succession flag is set to ‘1’ when the data are to be transferred successively. Also, the data succession validity flag is set to ‘1’ when the data succession flag is valid.

Referring to FIG. 8, data write processing initiated from external equipment (portable terminal) 4 or 6, via USB format converter 2, is explained hereafter, including a sequence for modifying the number of segments. As shown in FIG. 8, the USB format converter 2 (hereafter simply referred to as converter 2) inquires the external equipment 4, 6 of the data transfer amount, when initiated by the depression of transfer key 25 shown in FIGS. 1-3. The external equipment 4, 6 replies to the converter 2 with a file capacity and the number of transfer files, as data transfer amount.

On receiving transfer data (write data) from the external equipment 4 and 6, the converter 2 issues a write command using CDB. At this time, when a plurality of files or folders are transferred on a file-by-file, or folder-by-folder, basis, a transfer length (number of transfer blocks) according to the file size or the folder size is described in the 7th-8th bytes of the write command (CDB) of each transfer unit, as shown in FIG. 8. Also, in the 11th byte, the data succession validity flag ‘y’ and the data succession flag ‘z’ are described. The CDB including the above flag descriptions is generated by the format converter 22 and CPU 21 shown in FIG. 2.

On receiving this CDB, the MO unit 1 recognizes that the transfer of the blocks shown in the transfer length (the number of transfer blocks) of CDB is to succeed for a plurality of times. And referring to the segment division table 32 shown in FIG. 5, the MO unit 1 sets the number of segments according to the number of transfer blocks. The MO unit 1 then receives the write data from the converter 2, stores into the cache memory 18, and replies to the converter 2 with a write completion notification. The write data stored in the cache memory 18 is written on the MO disk by the drive 14.

As shown in FIG. 9, the MO unit 1 performs an initialization when the converter 2 is powered on (in case of USB, when the converter 2 detects current reception), and generates the segment management table 34 using the default value, so as to divide the cache memory 18 into segments each having small block size (that is, large number of segments). When a write command arrives from the converter 2, the command analyzer 30 in the disk controller 12 of the MO unit 1 performs processing for modifying the number of segments.

In the example shown in FIGS. 9 and 10, on identifying from the CDB that the data succession validity flag is ‘1’ and the data succession flag is ‘1’, the command analyzer 30 recognizes that 80 data transfer blocks (512 kilo bytes) are to be transferred successively. Then, referring to table 32 shown in FIG. 5, the command analyzer 30 determines the medium block size (that is, medium number of segments, =4). According to the determined number of divided segments, the command analyzer 30 updates the segment management table 34. Namely, as shown in FIG. 10, the segments initially divided into eight (8) are combined into four (4) divided segments.

In the example shown in FIG. 11, from the data succession validity flag is ‘1’ and the data succession flag is ‘1’ in the CDB, the command analyzer 30 recognizes that 300 data transfer blocks (1,920 kilo bytes) are to be transferred successively. Then, referring to the table 32 shown in FIG. 5, the command analyzer 30 determines the large block size (small number of segments, =1). According to the determined number of divided segments, the command analyzer 30 updates the segment management table 34. Namely, as shown in FIG. 11, the segments of the cache memory 18 initially divided into eight are combined into one.

Next, referring back to FIG. 9, the write data is transferred from the converter 2, and the disk controller 12 of the MO unit 1 stores the write data into the cache memory 18, on a basis of each segment having been determined according to the segment management table 34. Thereafter, the disk controller 12 transfers the write data in the cache memory 18 on a segment-by-segment basis to the drive 14. Thus, the data is written on the medium (MO disk). Then, write completion is notified to the converter 2.

FIGS. 12(A) and 12(B) show explanation diagrams of write operation on the disk drive. FIG. 12(A) illustrates the operation diagram of the MO drive in case that one segment is 32 K Byte, while FIG. 12B illustrates the operation diagram of the MO drive in case that one segment is 64 K Byte.

As shown in FIGS. 12(A) and 12(B), when data is input into the write buffer (cache memory 18), the MO unit 1 performs seek operation (S), positions the optical head on the instructed track, and performs erase (E), write (W) and verify (V) operations on the instructed sector (one or more sectors). Here, L (latency) denotes rotational latency time, etc.

Thus, when the write data exceeding 32 K Byte in one command arrives, when one segment is set to 32 K Byte as shown in FIG. 12(A), a series of sequence including seek, erase, write and verify operations is performed twice. Meanwhile, when one segment is set to 64 K Byte shown in FIG. 12(B), a series of sequence including seek, erase, write and verify operations is performed only once.

As a result, a time required for completing the write command in case of 64 K Byte per segment (FIG. 12(B)), is approximately two-thirds (130 ms/195 ms) of that in case of 32 K Byte per segment (FIG. 12(A)), and thus, the overhead time can be reduced. In particular, when the maximum transfer amount is extremely large, as in the case of image data, the case shown in FIG. 12(B) becomes more effective.

In contrast, when the maximum transfer amount in one command is 32 K Byte, the case of 32 K Byte/segment shown in FIG. 12(A) is preferable from the viewpoint of effective use of the cache memory 18.

Additionally, as shown in FIGS. 10 and 11, in case of a write command for the last successive data, the converter 2 sets the data succession validity flag (VALID) to ‘0’ (no more successive data). With this, after the write data following the last write command is stored in the cache memory 18, and written back on the MO disk, the number of segments is restored to the initial value.

According to the above first embodiment, by recognizing the succession of write data having the identical data transfer amount, using the data succession flag, and by modifying the number of segments of the cache memory 18 so as to fit to the data transfer amount concerned, it becomes possible to perform write processing at high speed, using the number of segments suitable for the write processing of the data transfer amount concerned.

Moreover, since notification from the converter 2 is performed using the CDB format, there is no need of command format change, and easy implementation can be made. Further, because of setting the necessary information into a write command, the number of commands to be issued from the converter 2 is not increased even after the implementation.

### Second Embodiment

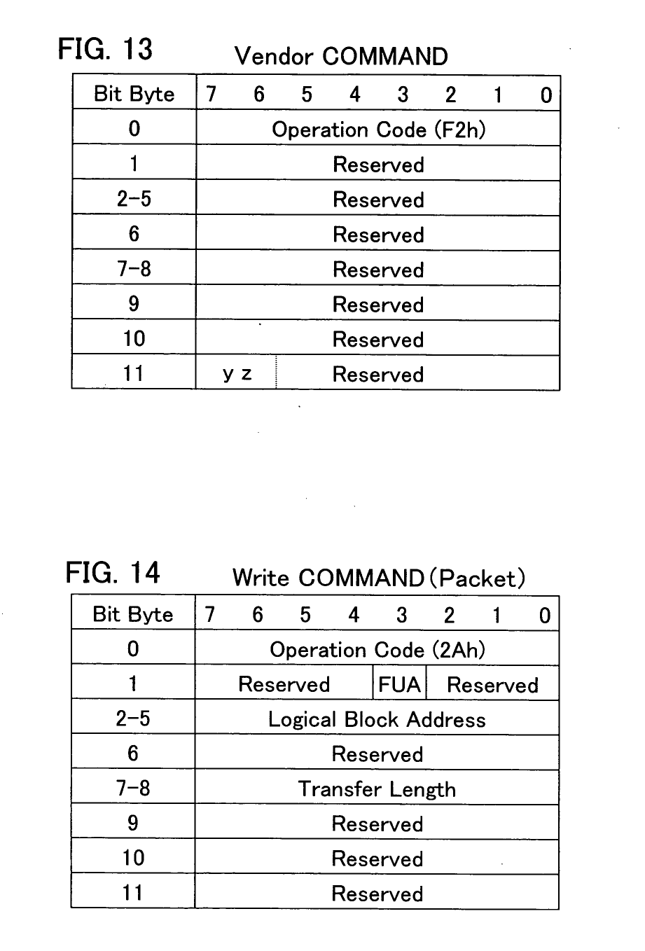

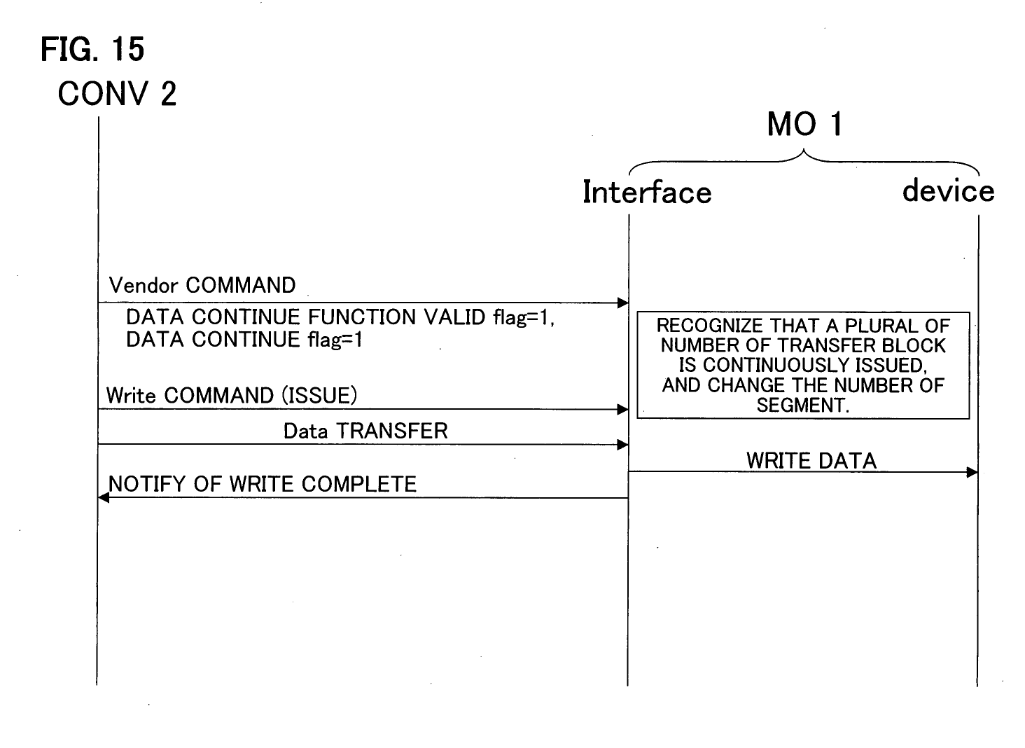

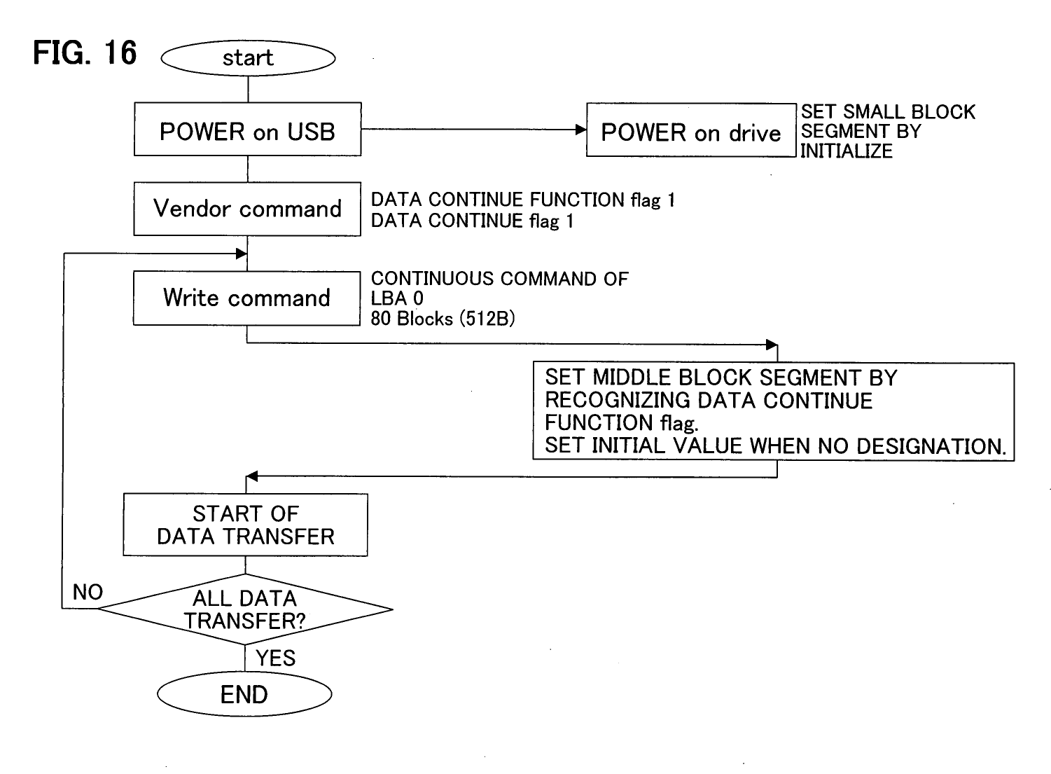

FIG. 13 is an explanation diagram of CDB (control data block) in a vendor command according to a second embodiment of the present invention; FIG. 14 is an explanation diagram of the CDB of a write command according to the second embodiment of the present invention; FIG. 15 is a sequence diagram of controlling the number of segments according to the second embodiment of the present invention; and FIG. 16 is a process flowchart of the control shown in FIG. 15.

As shown in FIGS. 13 and 14, a packet (CDB) to be issued from an upper-level device is constituted of 12 bytes. The 0-th byte is an operation code (write, read, etc.), the 2nd to the 5th bytes are a logical block address, and the 7th and 8th bytes are a transfer length. The remainder bytes are reserved, which can arbitrarily be used by a vender or a user.

In this embodiment also, in the reserved bytes of CDB, a data succession validity flag ‘y’ and a data succession flag ‘z’ are defined. As shown in FIG. 13, the vendor command is set in CDB, in which a code ‘F2(h)’ indicating the vendor command is set as operation code. The 2nd to the 10th bytes are reserved. In the 11th byte, the data succession validity flag ‘y’ and the data succession flag ‘z’ are described.

Further, in this embodiment, as shown in FIG. 14, a write command is set in CDB independently to the vendor command. In the write command, the 2nd to the 5th bytes are a logical block address, and the 7th and 8th bytes are a transfer length. The remainder bytes are reserved.

Referring to FIGS. 15 and 16, data write processing including a sequence for modifying the number of segments will be explained hereafter. In a similar way to FIG. 8, a USB format converter 2 (hereafter referred to as converter 2) inquires external equipment 4 and 6 of the data transfer amount by the depression of a transfer key 25 shown in FIGS. 1-3. The external equipment 4, 6 replies to the converter 2 with a file size capacity and the number of transfer files, as data transfer amount.

As shown in FIG. 15, on receiving transfer data (write data) from the external equipment 4 and 6, the converter 2 issues a vendor command using CDB. At this time, when a plurality of files or folders are transferred on a basis of a file or a folder, in the 11th byte of the vendor command, the data succession validity flag ‘y’ and the data succession flag ‘z’ are described as shown in FIG. 13.

Next, the converter 2 describes a transfer length (number of transfer blocks) according to the file size or the folder size, in the 7th-8th bytes of the write command (CDB) of each transfer unit, and issues the write command. The CDB including the above descriptions is generated by the format converter 22 and CPU 21 shown in FIG. 2.

On receiving these CDB of the vendor command and the write command, the MO unit 1 recognizes, from the CDB of the write command, the transfer for the number of blocks shown in CDB is to succeed for a plurality of times. And referring to the segment division table 32 shown in FIG. 5, the MO unit 1 sets the number of segments according to the number of transfer blocks. The MO unit 1 then receives the write data from the converter 2, stores into the cache memory 18, and replies to the converter 2 with a write completion notification. The write data stored in the cache memory 18 is written on the MO disk by the drive 14.

As shown in FIG. 16, the MO unit 1 performs initialization when the converter 2 is powered on (in case of USB, when the converter 2 receives current), and generates the segment management table 34 using the default value, so as to divide the segments in the cache memory 18 into a number of small blocks (large number of segments). When the vendor command and the write command arrive from the converter 2, the command analyzer 30 in the disk controller 12 of the MO unit 1 performs processing for modifying the number of segments.

In the example shown in FIG. 16, on identifying that the data succession validity flag is ‘1’ and the data succession flag is ‘1’ from the CDB in the vendor command, the command analyzer 30 recognizes that 80 data transfer blocks (512 kilobytes) are to be transferred successively. Then, referring to the table 32 shown in FIG. 5, the command analyzer 30 determines the medium block size (medium number of segments, =4). According to the determined number of divided segments, the command analyzer 30 updates the segment management table 34. Namely, as shown in FIG. 10, the segments divided into eight (8) as initial value is combined into four (4) divided segments.

Next, the write data is transferred from the converter 2, and the disk controller 12 of the MO unit 1 stores the write data into the cache memory 18, on a basis of each segment having been determined according to the segment management table 34. Thereafter, the disk controller 12 transfers the write data in cache memory 18, on a segment-by-segment basis, to the drive 14. Thus, the data is written on the medium (MO disk). Then, write completion is notified to the converter 2.

Similarly to the first embodiment, in this example according to the second embodiment, by modifying the number of segments of the cache memory 18 so as to fit to the maximum data transfer amount per command, it becomes possible to perform write processing at high speed, using the number of segments suitable for the write processing of the data transfer amount concerned.

Moreover, since notification from the converter 2 is performed using the CDB format, there is no need of command format change, and easy implementation can be made. Further, with the provision of the vendor command, modification by the vender's own setting is possible, without need of modification in the command system recognized on the converter (upper-level device) side.

Additionally, as use form of this vendor command, there are two cases of issuing the vendor command: issue by pairing with a write command; and issue prior to the first write command and the last write command, as shown in FIG. 16. In this example, as shown in FIGS. 10 and 11, the converter 2 sets the data succession validity flag (VALID) in CDB to ‘0’ (no more successive data) in the last vendor command of the successive data. With this, after the write data following the last write command is stored in the cache memory 18, and written back on the MO disk, the number of segments is restored to the initial value.

### Third Embodiment

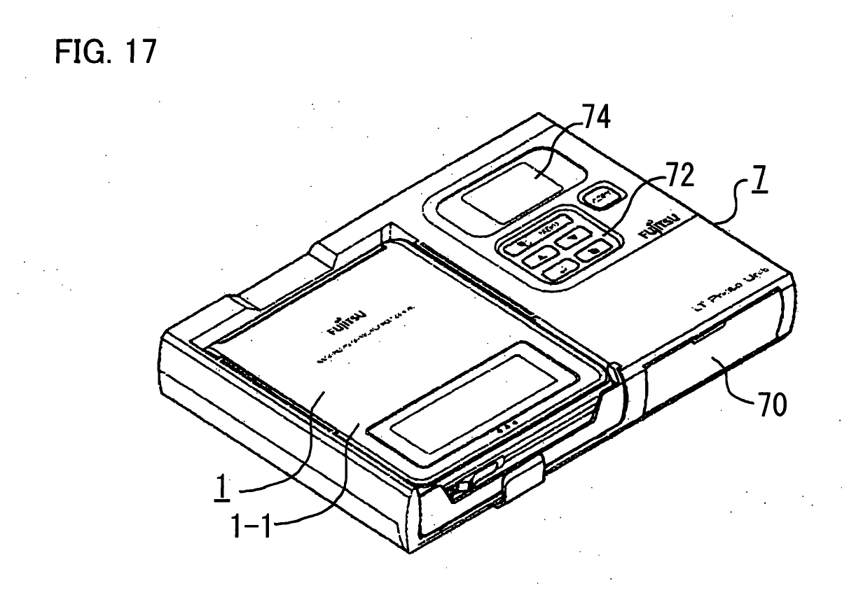

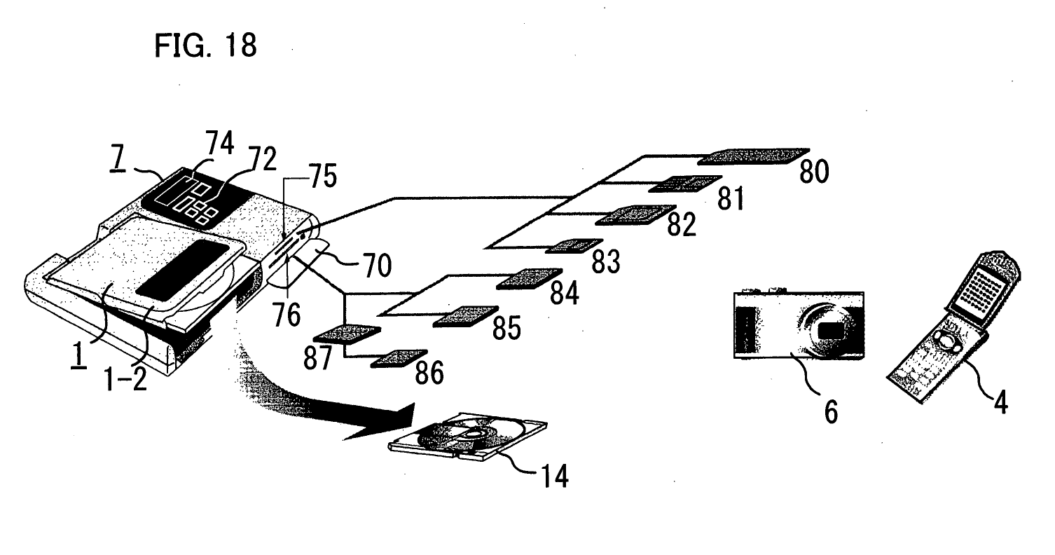

Next, application of the present invention to a composite media storage apparatus will be described. The composite media storage apparatus is a media storage with which a card reader is integrated. FIG. 17 is an outer view of the composite media storage system according to a third embodiment of the present invention. FIG. 18 is an explanation diagram of the use form of the apparatus shown in FIG. 17.

As shown in FIGS. 17 and 18, the MO unit 1 is disposed on one side of the main body of a composite storage apparatus 7. On the other side of composite storage apparatus 7, display section 74, operation key set 72, card slot cover 70 are disposed. As shown in FIG. 18, after a cover 1-2 is opened, an MO disk 14 can be inserted or ejected to/from the MO unit 1.

Meanwhile, by opening the card slot cover 70, two memory card insertion slots 75, 76 appear. In a first memory card insertion slot 75, one of the four types of memory cards, i.e. Memory Stick 80 (product name), Smart Media 81 (product name), SD Memory Card 82 (product name) and Multimedia Card 83 (product name), can be inserted, and read/write operation is performed on the inserted memory card.

On the other hand, in a second memory card insertion slot 76, one of the three types of memory cards etc., i.e. Compact Flash (registered trademark) 84, Micro Drive (HDD) 85 (product name) and xD-Picture Card 86 (product name) can be inserted, and read/write operation is performed on the inserted memory card, etc. Here, the xD-Picture Card is inserted via a conversion adaptor 87.

These memory cards 80-86 are mounted on a portable telephone 4 or a digital camera 6, and image data photographed by portable telephone 4 or digital camera 6, and/or character data are stored in these memory cards 80-86. Since each memory card 80-86 has a relatively small capacity, necessary data are duplicated on a large-capacity MO disk 14 and preserved.

The composite storage apparatus 7 accepts the memory card 80-86, reads out the image data stored in the memory card 80-86, and writes the readout data on the MO disk 14 of the MO unit 1. At this time, the readout images are displayed on a display section 74. Then, through the operation of operation keys 72, a desired image is selected and displayed, and only the desired image is written on the MO disk 14. In such a way, so-called editing can be performed.

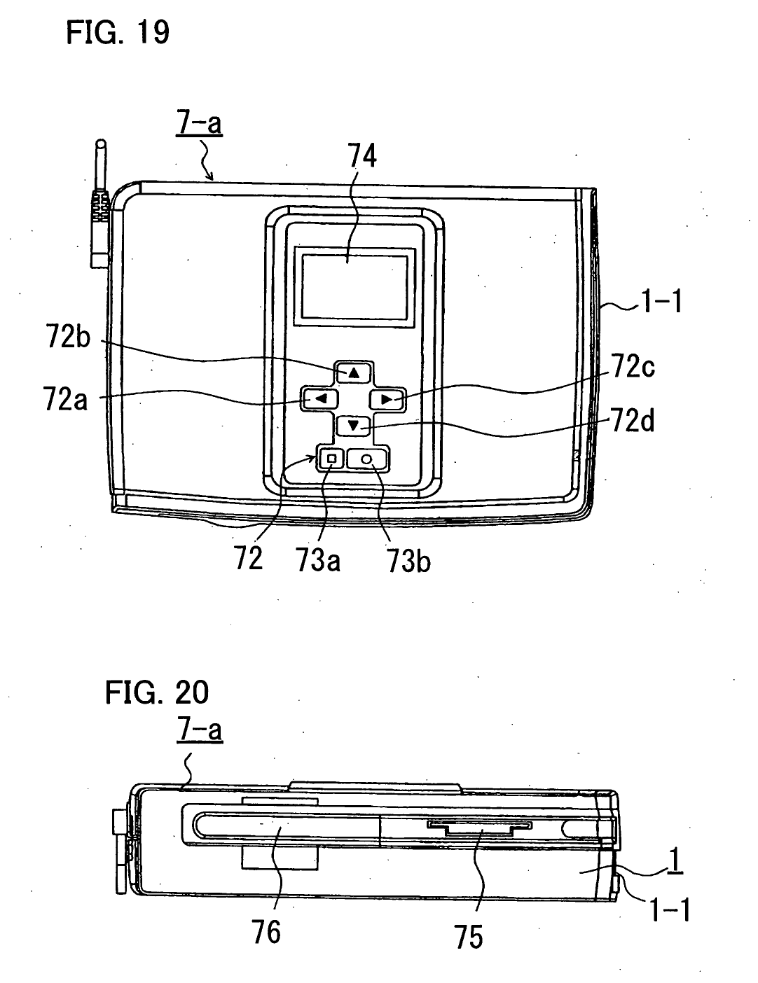

Similarly, FIGS. 19 and 20 are outer views of a composite media storage system according to the fourth embodiment of the present invention. A composite media storage system 7-a shown in FIGS. 19 and 20 has functions similar to the composite media storage apparatus shown in FIGS. 17 and 18, and additionally, a display function to an external display is provided.

FIG. 19 is an upper plan view of composite media storage apparatus 7-a, and FIG. 20 is a side plan view thereof. In these figures, like parts shown in FIGS. 17, 18 are designated by like reference numerals. As shown in FIGS. 19 and 20, memory card insertion slots 75 and 76, display section 74, and necessary operation key set 72 (72a-72d, 73a, 73b) are disposed on the MO unit 1.

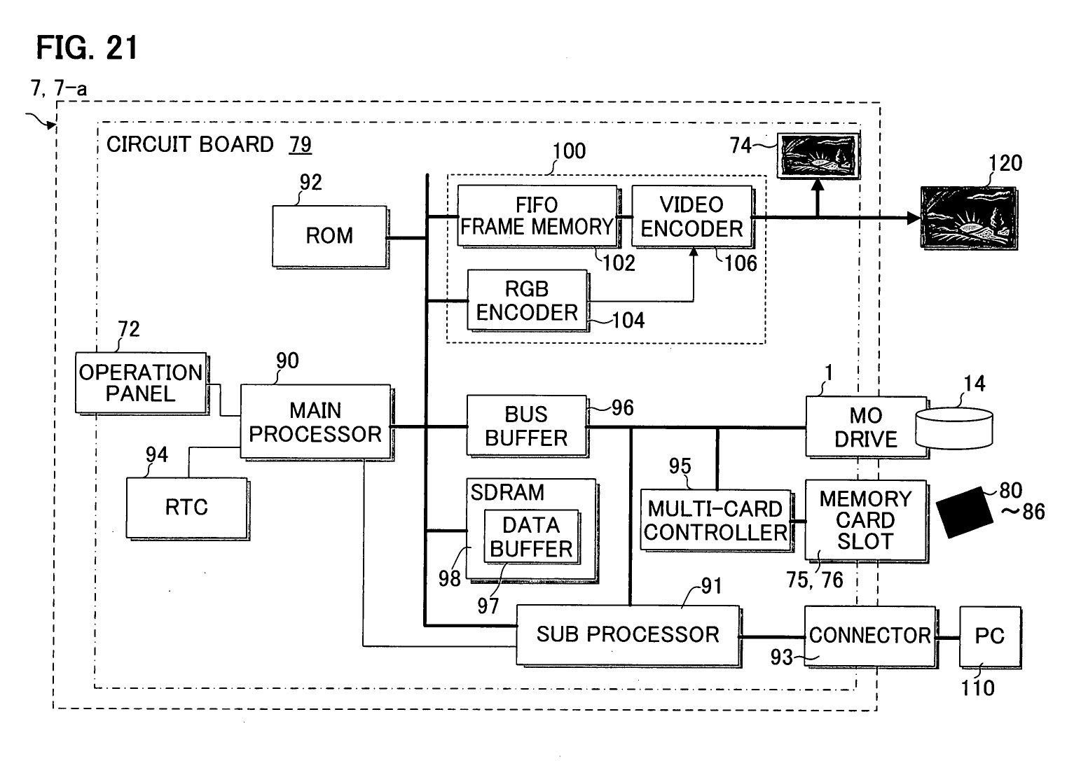

FIG. 21 is a block diagram of composite media storage apparatus 7-a shown in FIG. 19. As shown in FIG. 21, a circuit board 79 includes a main processor 90 which performs reading the card and controlling both the MO drive 1 and the display section 74, a ROM (read-only memory) 92 in which programs and parameters for performing above display and control are stored, an operation section 72, and a real-time clock 94.

Further, in connection to main processor 90, a video control circuit 100, an SDRAM (synchronous dynamic random access memory) 98 having a bus buffer 96 and a data buffer 97, and a bridge sub-processor 91 are provided on circuit board 79. The video control circuit 100 includes a FIFO (fast in, fast out) frame memory 102, RGB encoder 104 and video encoder 106. The video control circuit 100 converts image data to video signals, and outputs the converted signals to the internal display section 74 and the external display unit 120.

Bus buffer 96 is connected to MO drive 1, multi-card controller 95 and bridge sub-processor 91. The multi-card controller 95 is connected to the memory card slots 75 and 76 shown in FIGS. 17-20, and performs read/write control according to each type of the variety of the memory cards 80-86. Further, the bridge sub-processor 91 is connected to PC connectors 93 for the interfaces of IEEE, USB, ATAPI (Advanced Technology Attachment Packet Interface), etc., and is connected to an external personal computer (PC) 110.

This composite storage apparatus 7-a can display the image data stored in the memory cards 80-86 to the display section 74 or the external display unit 120, and also can select a necessary image according to the operation of operation section 72. Also, the operation of CPU 21 and the format converter 22 performed in the aforementioned the converter 2 is performed by main processor 90, in which the aforementioned control of the number of segments by use of the data succession flag having been explained in the first and the second embodiments can be achieved. This case corresponds to write processing from the memory card to the MO drive 1.

Similarly, it is possible to access the MO drive 1 from the PC 110, through the bridge sub-processor 91. Namely, the aforementioned control of the number of segments by use of the data succession flag, which was explained in the first and the second embodiments, can be achieved between the devices connected by an internal bus, not only to/from an external device.

### Other Embodiments

In the aforementioned embodiments, as media storage apparatus, the magneto-optical disk unit is exemplified. However, it is also possible to apply to other media storage apparatuses, such as magnetic disk unit, optical disk unit. Also, though the description has been given on a case of USB connection, it is also possible to apply other interfaces such as ATAPI. Furthermore, the capacity of the cache memory and the number of segments are not limited to those described in the above embodiments. USB format converter 2 may also be of connection adapter type. By providing an antenna, etc., the present invention is applicable to apparatuses in which wireless data transfer is applied.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A media storage apparatus for storing write data transferred from an external device, and comprising:
a media drive unit for recording data on a medium;
a cache memory for storing the write data transferred from the external device; and
a controller for managing the number of segments in the cache memory, and recording the write data stored in the cache memory on the media drive unit,
wherein the controller sets the number of segments of the cache memory according to data succession information and a data transfer amount per command, which are notified from the external device prior to the write data transfer.

2. The media storage apparatus according to claim 1, wherein the controller sets the number of segments of the cache memory according to the data succession information and the data transfer amount, which are notified from the external device using the CDB format, prior to the write data transfer.

3. The media storage apparatus according to claim 1, wherein the controller has a table for storing the number of segments of the cache memory depending on the data transfer amount from the external device,
and wherein the controller sets the number of segments of the cache memory by referring to the table when receiving the data succession information.

4. The media storage apparatus according to claim 1,
wherein the controller sets the number of segments of the cache memory according to the data succession information and the data transfer amount, which are set in a write command notified from the external device using the CDB format, prior to the write data transfer.

5. The media storage apparatus according to claim 1,
wherein the controller sets the number of segments of the cache memory according to the data succession information being set in a vendor command, and the data transfer amount being set in a write command, which are notified from the external device using the CDB format, prior to the write data transfer.

6. The media storage apparatus according to claim 1,
wherein the controller controls the media drive unit to perform write operation on a basis of each segment of the cache memory.

7. The media storage apparatus according to claim 1,
wherein the media drive unit comprises a drive mechanism which writes data on the medium with a head.

8. A cache segment switching method of a media storage apparatus storing write data transferred from an external device, comprising the steps of:
setting the number of segments in a cache memory according to data succession information and a data transfer amount per command, which are notified from the external device prior to the write data transfer;
storing the write data transferred from the external device into the cache memory on a basis of each set segment of the cache memory; and
recording the write data stored in the cache memory on a media drive unit.

9. The cache segment switching method according to claim 8,
wherein the setting step comprises a step of setting the number of segments of the cache memory according to the data succession information and the data transfer amount per command, which are notified from the external device using the CDB format, prior to the write data transfer.

10. The cache segment switching method according to claim 8,
wherein the setting step comprises a step of setting the number of segments of the cache memory, by referring to a table in which the number of segments of the cache memory depending on the data transfer amount from the external device is stored.

11. The cache segment switching method according to claim 8,
wherein the setting step comprises a step of setting the number of segments of the cache memory according to the data succession information and the data transfer amount per command, which are set in a write command notified from the external device using the CDB format, prior to the write data transfer.

12. The cache segment switching method according to claim 8,
wherein the setting step comprises a step of setting the number of segments of the cache memory according to the data succession information being set in a vendor command, and the data transfer amount per command being set in a write command, which are notified from the external device using the CDB format, prior to the write data transfer.

13. The cache segment switching method according to claim 8,
wherein the recording step comprises a step of controlling the media drive unit to perform write operation on a basis of each segment of the cache memory.

14. The cache segment switching method according to claim 8,
wherein the recording step comprises a step of writing data on a medium with a head.

15. A media storage system comprising:
an external device for issuing a write command and write data; and
a media storage apparatus for storing the write data transferred from the external device,
wherein said media storage apparatus further comprising:
a media drive unit for recording data on a medium;
a cache memory for storing the write data transferred from the external device; and
a controller for managing the number of segments in the cache memory, and recording the write data stored in the cache memory on the media drive unit,
wherein the external device notifies the media storage apparatus of data succession information of the write data and a data transfer amount per command, prior to the write data transfer,
and the controller sets the number of segments of the cache memory according to the data succession information and the data transfer amount per command.

16. The media storage system according to claim 15,
wherein the external device notifies the media storage apparatus of the data succession information and the data transfer amount per command, using the CDB format, prior to the write data transfer.

17. The media storage system according to claim 15,
wherein the controller has a table in which the number of segments of the cache memory depending on the data transfer amount from the external device is stored, and on receipt of the data succession information, the controller sets the number of segments of the cache memory by referring to the table.

18. The media storage system according to claim 15,
wherein the external device sets the data succession information and the data transfer amount per command into a write command with the CDB format, prior to the write data transfer.

19. The media storage system according to claim 15,
wherein the external device sets the data succession information into a vendor command with the CDB format, and sets the data transfer amount per command into a write command with the CDB format, prior to the write data transfer.

20. The media storage system according to claim 15,
wherein the controller controls the media drive unit to perform write operation on a basis of each segment of the cache memory.
